(19) United States
(12) Patent Application Publication
(10) Pub. No.: US 2023/0128848 A1
(43) Pub. Date: Apr. 27, 2023

(54) INFORMATION PROCESSING DEVICE

(71) Applicant: TOYOTA JIDOSHA KABUSHIKI KAISHA, Toyota-shi (JP)

(72) Inventors: Yuki KUDO, Susono-shi (JP); Kazutaka KIMURA, Mishima-shi (JP); Kazuki OBATA, Susono-shi (JP); Hiromitsu KIGURE, Ashigarakami-gun (JP); Satoshi KIKUCHI, Hadano-shi (JP); Yuta MANIWA, Susono-shi (JP)

(73) Assignee: TOYOTA JIDOSHA KABUSHIKI KAISHA, Toyota-shi (JP)

(21) Appl. No.: 17/944,531

(22) Filed: Sep. 14, 2022

(30) Foreign Application Priority Data
Oct. 27, 2021 (JP) 2021-175342

(51) Int. Cl. G06Q 50/06; G06Q 30/02; G06Q 20/14; G06Q 30/08; G06Q 30/06

(52) U.S. Cl. CPC G06Q 50/06; G06Q 30/0283; G06Q 20/145; G06Q 30/08; G06Q 30/0611; G06Q 30/0637

(57) ABSTRACT

A market electricity price prediction unit is configured to predict a transaction price of electricity traded in an electricity transaction market. A user use prediction unit is configured to predict a use plan of a vehicle by a user of the vehicle. An electricity transaction plan preparation unit is configured to prepare an electricity transaction plan based on a prediction result of the market electricity price prediction unit and a prediction result of the user use prediction unit. The user inquiry performing unit is configured to make an inquiry to the user about the electricity transaction plan before an electricity transaction according to the electricity transaction plan is contracted in the electricity transaction market.

### CROSS-REFERENCE TO RELATED APPLICATION

This application claims priority to Japanese Patent Application No. 2021-175342 filed on Oct. 27, 2021, incorporated herein by reference in its entirety.

### BACKGROUND

### 1. Technical Field

The present disclosure relates to an information processing device, and more specifically, relates to an information processing device that prepares an electricity transaction plan for an electricity resource to conduct an electricity transaction through an electricity transaction market.

### 2. Description of Related Art

Japanese Unexamined Patent Application Publication No. 2012-196028 (JP 2012-196028 A) discloses an electricity management system that, when an electricity demand facility such as a factory uses electricity stored in a battery of an electric vehicle, performs an electricity management between the electric vehicle and the factory. With this electricity management system, it is described that it is possible to prevent the consumption of grid electricity from exceeding a predetermined amount of electricity by using the electricity stored in the battery of the electric vehicle in the electricity demand facility so that it is possible to perform the optimal electricity management when the predetermined amount of electricity is the limit value (see JP 2012-196028 A).

### SUMMARY

The liberalization of electricity has led to a consideration of introduction of P2P (Peer to Peer) electricity transactions on an electricity transaction market, in which transactions of selling and buying electricity are conducted directly between an individual or corporation and a different individual or corporation each having an electricity resource. For example, an individual user having a vehicle (electric vehicle or the like) as an electricity resource is able to conduct an electricity transaction with an individual or corporation having another electricity resource through the electricity transaction market.

In the electricity transaction using the vehicle as the electricity resource, for example, an electricity transaction price in the electricity transaction market is predicted, a use plan of the vehicle by a user of the vehicle is predicted, and an electricity transaction plan (a tender plan) is prepared based on those prediction results. However, when the use prediction of the vehicle and the action of the user deviate from each other, a penalty may be imposed due to transaction failure, the reliability of the user on the electricity transaction plan to be prepared may be reduced, and so forth.

The present disclosure has been made for solving the problem described above, and it is an object of the present disclosure to provide an information processing device that is able to prepare an electricity transaction plan in line with an action of a vehicle user when a P2P electricity transaction is conducted using a vehicle as an electricity resource.

One aspect of the present disclosure relates to an information processing device configured to prepare an electricity transaction plan for a vehicle as an electricity resource to conduct an electricity transaction through an electricity transaction market. The information processing device includes a price prediction unit, a use prediction unit, a transaction plan preparation unit, and an inquiry performing unit. The price prediction unit is configured to predict a transaction price of electricity traded in the electricity transaction market. The use prediction unit is configured to predict a use plan of the vehicle by a user of the vehicle. The transaction plan preparation unit is configured to prepare the electricity transaction plan based on a prediction result of the price prediction unit and a prediction result of the use prediction unit. The inquiry performing unit is configured to make an inquiry to the user about the electricity transaction plan before an electricity transaction according to the electricity transaction plan is contracted in the electricity transaction market.

With the information processing device according to the above-described aspect, since the inquiry about the electricity transaction plan is made to the user by the inquiry performing unit before the electricity transaction is contracted in the electricity transaction market, it is possible to reflect an answer from the user on the preparation of the electricity transaction plan, or the user is able to match its action to the inquired electricity transaction plan. In this way, with the information processing device described above, it is possible to prepare the electricity transaction plan in line with the action of the vehicle user.

In the information processing device according to the above-described aspect, the inquiry performing unit may be configured to make an inquiry to the user about an action plan of the user using the vehicle, and the transaction plan preparation unit may be configured to prepare the electricity transaction plan reflecting an answer from the user to the inquiry.

With this configuration, it is possible to suppress a deviation between the use prediction of the vehicle and the action of the user so that it is possible to prepare the electricity transaction plan reflecting the action plan of the vehicle user.

In the information processing device according to the above-described aspect, the inquiry performing unit may be configured to make an inquiry to the user about a ratio of renewable energy electricity accounting for electricity purchased in the electricity transaction market, and the transaction plan preparation unit may be configured to prepare the electricity transaction plan reflecting an answer from the user to the inquiry.

In the information processing device according to the above-described aspect, the inquiry performing unit may be configured to make an inquiry to the user about an electricity cost allowable when an electricity transaction is conducted in the electricity transaction market, and the transaction plan preparation unit may be configured to prepare the electricity transaction plan reflecting an answer from the user to the inquiry.

With the configuration described above, the user is able to answer on the ratio of the renewable energy electricity or the allowable electricity cost so that the electricity transaction plan reflecting the answer from the user is prepared. Consequently, the user's usability to the information processing device is improved.

In the information processing device according to the above-described aspect, the inquiry performing unit may be configured to make an inquiry to the user about approval or disapproval of the electricity transaction plan prepared by the transaction plan preparation unit, and the transaction plan preparation unit may be configured to prepare again the electricity transaction plan reflecting an answer from the user to the inquiry.

With this configuration, the user is able to answer about the approval or disapproval of the prepared electricity transaction plan so that the electricity transaction plan reflecting the answer from the user is prepared. Consequently, the user's usability to the information processing device is improved.

In the information processing device according to the above-described aspect, the inquiry performing unit may be configured to make an inquiry to the user about an evaluation of the electricity transaction plan prepared by the transaction plan preparation unit, and the transaction plan preparation unit may be configured to prepare the electricity transaction plan reflecting an answer of the evaluation from the user to the inquiry.

With this configuration, the user is able to answer about the evaluation of the prepared electricity transaction plan so that the user's evaluation of the electricity transaction plan can be reflected on the preparation of the next electricity transaction plan. Consequently, the user's usability to the information processing device is further improved.

In the information processing device according to the above-described aspect, the inquiry performing unit may be configured to notify to the user a contract result of an electricity transaction in the electricity transaction market according to the electricity transaction plan.

With this configuration, the user is able to evaluate the contract result of the electricity transaction and answer about the result of the evaluation so that it is possible to reflect the contract result on the preparation of an electricity transaction plan from the next time.

In the information processing device according to the above-described aspect, the inquiry performing unit may be configured to make an inquiry to the user about an evaluation of a contract result of an electricity transaction according to the electricity transaction plan, and the transaction plan preparation unit may be configured to prepare the electricity transaction plan reflecting an answer of the evaluation from the user to the inquiry.

With this configuration, the user is able to answer about the evaluation of the contract result of the electricity transaction in the electricity transaction market so that the user's evaluation of the contract result can be reflected on the preparation of the next electricity transaction plan. Consequently, the user's usability to the information processing device is further improved.

With the information processing device of the present disclosure, it is possible to prepare an electricity transaction plan in line with an action of a vehicle user when a P2P electricity transaction is conducted using a vehicle as an electricity resource.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration example of a transmission and distribution system of electricity that is traded using an information processing device according to an embodiment;

FIG. 2 is a diagram schematically illustrating an example of a P2P electricity transaction market;

FIG. 3 is a diagram for describing an example of tendering on a general transaction market in a P2P electricity transaction;

FIG. 4 is a diagram for describing an example of tendering on a direct transaction market in a P2P electricity transaction;

FIG. 5 is a diagram illustrating an example of hardware configurations of an agent and a transaction market server:

FIG. 6 is a diagram illustrating an example of resource information;

FIG. 7 is a diagram illustrating an example of agent information;

FIG. 8 is a block diagram functionally illustrating a configuration of an agent (a mobile object agent) according to the embodiment;

FIG. 9 is a flowchart illustrating an example of a procedure of processing that is performed when an agent places a tender on a P2P electricity transaction market;

FIG. 10 is a flowchart illustrating an example of a processing procedure of an agent according to a first modification;

FIG. 11 is a flowchart illustrating an example of a processing procedure of an agent according to a second modification;

FIG. 12 is a flowchart illustrating an example of a processing procedure of an agent according to a third modification; and

FIG. 13 is a block diagram functionally illustrating a configuration of an agent (a mobile object agent) according to a fourth modification.

### DETAILED DESCRIPTION OF EMBODIMENTS

Hereinafter, an embodiment of the present disclosure will be described in detail with reference to the accompanying drawings. While the embodiment and a plurality of modifications will be described below, it is expected at the time of the application that those configurations may be combined as appropriate. In the drawings, the same signs are assigned to the same or corresponding elements, and a description thereof is not repeated.

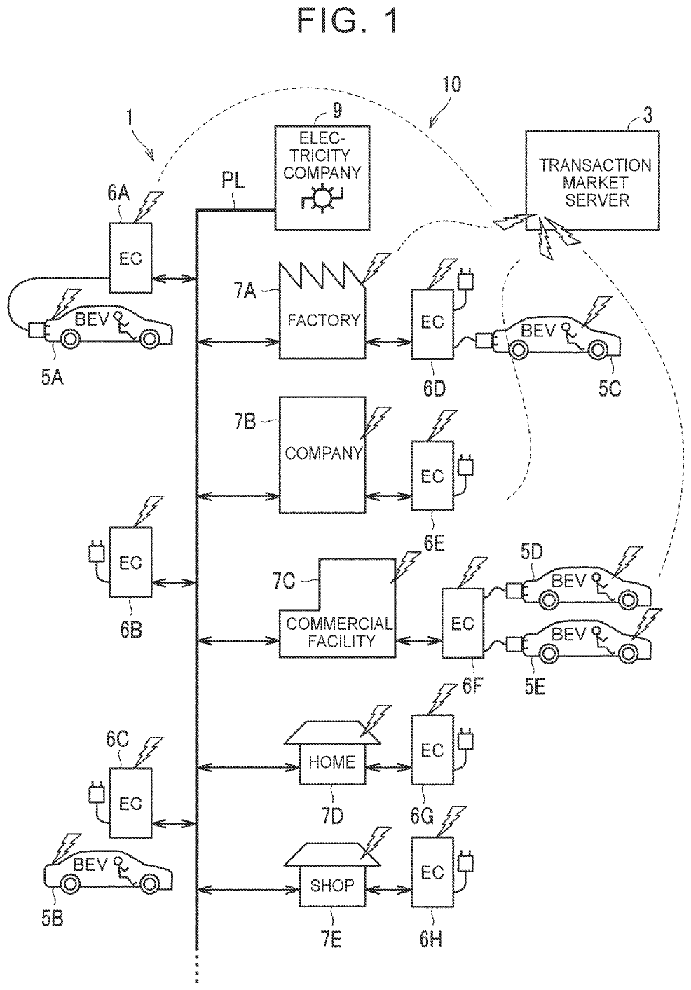

FIG. 1 is a diagram schematically illustrating a configuration example of a transmission and distribution system of electricity that is traded using an information processing device according to this embodiment. Referring to FIG. 1, an electricity transmission and distribution system 1 includes a plurality of electricity resources, charge-discharge devices 6A to 6H, an electricity company 9, an electricity grid PL, a transaction market server 3, and a communication network 10.

The electricity resources include, for example, electrically driven vehicles 5A to 5E, a factory 7A, a company 7B, a commercial facility 7C, a home 7D, and a shop 7E. Each of the electricity resources is configured to be able to transfer electricity to and from the other electricity resource through the electricity grid PL or directly.

The number of the electrically driven vehicles and the number of the charge-discharge devices are not limited to the numbers illustrated. Further, the facilities such as the factory 7A are also not limited to those illustrated. Hereinafter, there are cases where the electrically driven vehicles 5A to 5E will each be referred to as “the electrically driven vehicle 5” without distinction, and there are cases where the charge-discharge devices 6A to 6H will each be referred to as “the charge-discharge device 6” without distinction. Further, there are cases where the factory 7A, the company 7B, the commercial facility 7C, the home 7D, and the shop 7E will each be referred to as “the facility 7” without distinction.

The electrically driven vehicle 5 is an electrically driven vehicle that can travel using electricity stored in a battery, and may be, for example, a battery electric vehicle (BEV) or a plug-in hybrid electric vehicle (PHEV). Hereinafter, it is assumed that the electrically driven vehicle 5 is the BEV. The electrically driven vehicle 5 is configured to be electrically connectable to the charge-discharge device 6 and is able to transfer electricity to and from the electricity grid PL or the facility 7 through the charge-discharge device 6.

The facility 7 is electrically connected to the electricity grid PL and is able to transfer electricity to and from the electricity grid PL. Further, the facility 7 is also electrically connected to the charge-discharge device 6 and is able to transfer electricity to and from the electrically driven vehicle 5 connected to the charge-discharge device 6.

The charge-discharge device 6 is electrically connected to the electricity grid PL or the facility 7. The charge-discharge device 6 is electrically connectable to the electrically driven vehicle 5 through an electricity cable so that the electrically driven vehicle 5 is able to transfer electricity to and from the electricity grid PL or the facility 7 through the charge-discharge device 6 to which the electrically driven vehicle 5 is electrically connected.

Electricity generated in an electricity generation plant managed by the electricity company 9 is supplied to the facilities 7 through the electricity grid PL (the grid-electricity network) and can also be supplied to the electrically driven vehicles 5 connected to the charge-discharge devices 6. Conventionally, in this way, electricity is supplied to the facilities 7 and the electrically driven vehicles 5 exclusively from the electricity generation plant of the electricity company 9 through the electricity grid PL. In the electricity transmission and distribution system 1, it is possible to conduct electricity sell-buy transactions between individuals and/or corporations (the electrically driven vehicles 5 and/or the facilities 7), i.e., P2P electricity transactions.

The transaction market server 3 provides a platform for conducting such P2P electricity transactions. The transaction market server 3 is configured to be able to communicate with the electrically driven vehicles 5, the charge-discharge devices 6, and the facilities 7 through the communication network 10. When the facility 7 or the electrically driven vehicle 5 wishes a P2P electricity transaction, the facility 7 or the electrically driven vehicle 5 (specifically, an agent that conducts an electricity transaction of the facility 7 or the electrically driven vehicle 5, which will be described later) places a tender offering as tender conditions, for example, a time period in which the facility 7 or the electrically driven vehicle 5 wishes to sell or buy electricity, a sell-buy amount of electricity per unit time period, a transaction price, and so forth, to the transaction market server 3 managing a P2P electricity transaction market where the facility 7 or the electrically driven vehicle 5 wishes to conduct an electricity transaction. According to an arbitrary algorithm, the transaction market server 3 executes a contract for an electricity transaction between a seller and a buyer with matching tender conditions and processes a tender with no condition matching counterpart as an uncontracted tender. Note that “tender” means an action of ordering an electricity transaction (selling or buying), or such an order itself. On the other hand, “contract” means an action of determining to conduct an electricity transaction tendered, or such a determination itself.

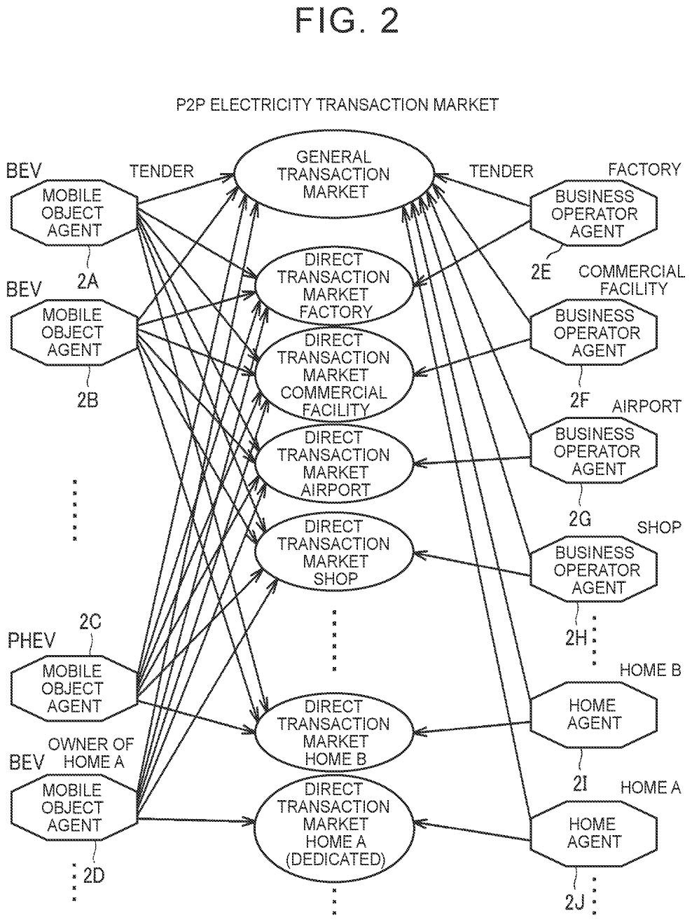

FIG. 2 is a diagram schematically illustrating an example of a P2P electricity transaction market. Referring to FIG. 2, in the P2P electricity transaction market, planning and execution of a tender, management of a contract, preparation of a charge-discharge plan based on a contract, and so forth are performed by an “agent” that places a tender on the P2P electricity transaction market. The agent is provided for each of the facilities 7 and the electrically driven vehicles 5. In this embodiment, there exist a plurality of mobile object agents 2A to 2D corresponding to the electrically driven vehicles 5, a plurality of business operator agents 2E to 2H corresponding to the factory 7A and so forth, and a plurality of home agents 2I, 2J corresponding to homes. For example, to give a description representatively on the electrically driven vehicle 5, the mobile object agent of the electrically driven vehicle 5 prepares an electricity transaction plan (a tender plan) in the P2P electricity transaction market and places a tender on the P2P electricity transaction market (i.e., to the transaction market server 3).

Hereinafter, there are cases where the mobile object agents 2A to 2D, the business operator agents 2E to 2H, and the home agents 2I, 2J will each be referred to simply as “the agent 2” without distinction. The agent 2 is an “information processing device” that prepares an electricity transaction plan for the corresponding electricity resource to conduct an electricity transaction through the P2P electricity transaction market.

The P2P electricity transaction market includes a “general transaction market” and “direct transaction markets”. The general transaction market is a market that deals with a transaction of electricity transmitted through the electricity grid PL. In the general transaction market, an unspecified large number of the agents 2 can participate in electricity transactions. In the general transaction market, an electricity transaction is contracted (matching) according to an arbitrary rule determined by an administrator managing the P2P electricity transaction market. As a matching rule, there is, for example, a method of establishing a transaction on a first-come, first-served basis when a price offered by a seller and a price offered by a buyer match each other in a unit time period. As another matching rule, it is also possible to employ a method of establishing a transaction at an appropriate price after once sorting tenders (orders) of sellers and buyers placed in a unit time period.

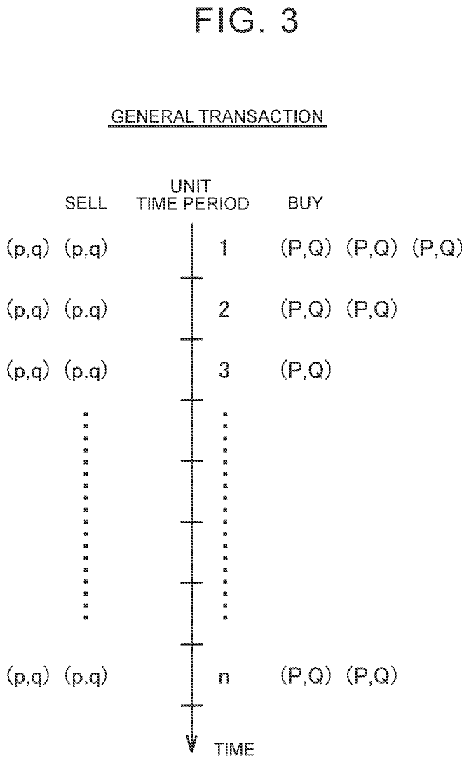

FIG. 3 is a diagram for describing an example of tendering on the general transaction market in a P2P electricity transaction. Referring to FIG. 3, on the general transaction market, per unit time period (1, 2, . . . , n), an unspecified large number of sellers place tenders (p, q) that are pairs of a sell price and an amount of electricity, and an unspecified large number of buyers place tenders (P. Q) that are pairs of a buy price and an amount of electricity. The unit time period is a time width (e.g., 30 minutes) set in the general transaction market. A transaction of an amount of electricity is conducted per amount of electricity transmitted in the unit time period (electricity x length of unit time period).

Referring back to FIG. 2, the direct transaction market is a market that deals with a transaction of electricity transmitted not through the electricity grid PL such that the electrically driven vehicle 5 moves to a place of the facility 7. In the direct transaction market, only an agent having an identification (ID) of the direct transaction market can participate in an electricity transaction. In the direct transaction market, one market is formed for the single facility 7 where the charge-discharge device 6 is installed. A server provided for each of the facilities 7 may manage one direct transaction market, or a plurality of direct transaction markets each formed for the facility 7 may be managed by a common server. On each of the direct transaction markets, an electricity transaction is contracted (matching) according to an arbitrary rule uniquely determined by an administrator of the market. As a matching rule, it is possible to employ the method described above for the general transaction market.

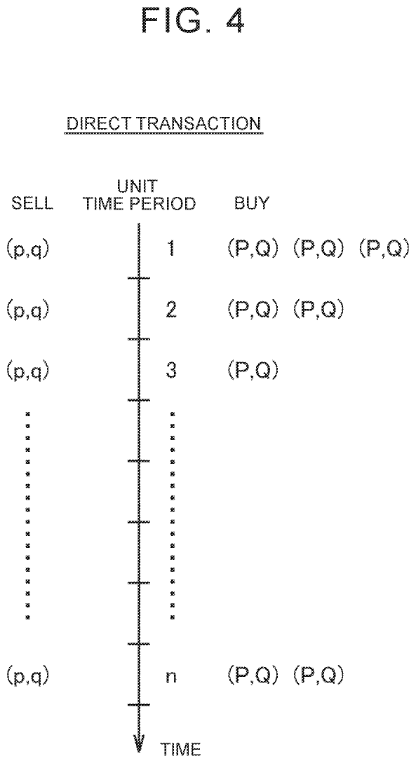

FIG. 4 is a diagram for describing an example of tendering on the direct transaction market in a P2P electricity transaction. Referring to FIG. 4, on the direct transaction market, per unit time period (1, 2, . . . , n), a seller offers a tender (p, q) that is a pair of a sell price and an amount of electricity, and, on this offer, a plurality of buyers having an ID of the direct transaction market place tenders (P, Q) that are pairs of a buy price and an amount of electricity. The unit time period is a time width individually set in the direct transaction market. A transaction of an amount of electricity is conducted per amount of electricity transmitted in the unit time period (electricity x length of unit time period).

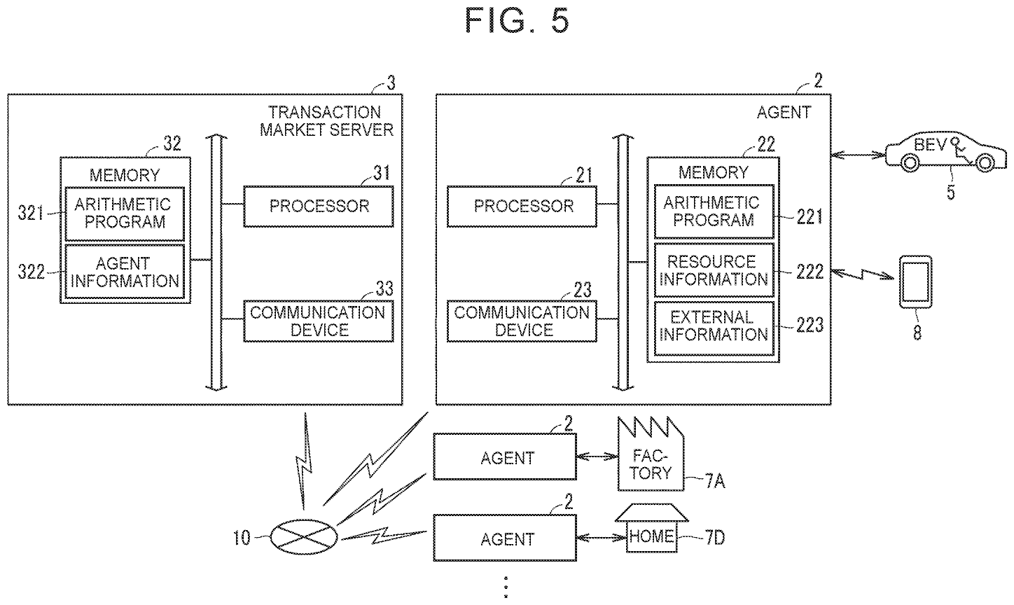

FIG. 5 is a diagram illustrating an example of hardware configurations of the agent 2 and the transaction market server 3. Referring to FIG. 5, the agent 2 includes a processor 21, a memory 22, and a communication device 23. The agent 2 is provided for each of the electricity resources, i.e., the electrically driven vehicles 5 and the facilities 7 (the factory 7A, the home 7D, etc.). The agent 2 may be provided in the corresponding electricity resource, or may be provided in a cloud that can communicate with the corresponding electricity resource.

The processor 21 is an arithmetic processor (a computer) that performs various processes by executing various programs. The processor 21 is formed by a central processing unit (CPU), a field-programmable gate array (FPGA), a graphics processing unit (GPU), and so forth. Alternatively, the processor 21 may be formed by a processing circuitry.

The memory 22 stores programs and data for the processor 21 to perform various processes. The memory 22 is formed by storage media such as a read only memory (ROM) and a random access memory (RAM). The memory 22 stores an arithmetic program 221, resource information 222, and external information 223.

The arithmetic program 221 is for identifying a process to be performed by the processor 21. For example, the arithmetic program 221 includes a program for placing a tender for an electricity transaction to the transaction market server 3 on a P2P electricity transaction market managed by the transaction market server 3.

The resource information 222 includes information on an electricity resource (e.g., the electrically driven vehicle 5) corresponding to the agent 2 and particularly includes information on a tender and a contract for an electricity transaction.

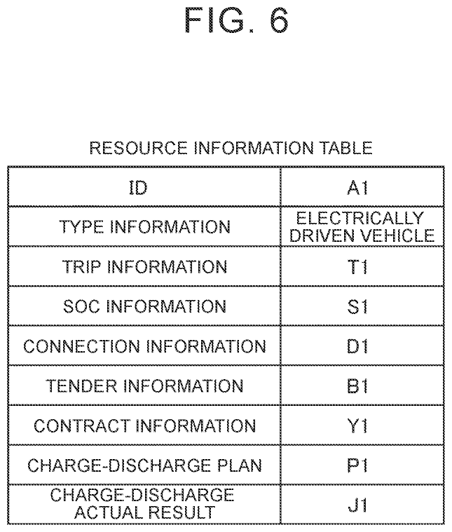

FIG. 6 is a diagram illustrating an example of the resource information 222. In FIG. 6, the resource information 222 in the agent 2 of the electrically driven vehicle 5 (the mobile object agent) is illustrated by way of example.

Referring to FIG. 6, the resource information 222 includes ID, type information, trip information, state-of-charge (SOC) information, connection information, tender information, contract information, charge-discharge plan, and charge-discharge actual result.

The ID includes identification information for identifying an electricity resource (in this example, the electrically driven vehicle 5). The type information includes information on the type of an electricity resource and, for example, includes information for identifying an electrically driven vehicle, a business operator, a home, or the like. The trip information includes information on a travel history such as past travel route and travel time. The SOC information includes information on the amount of electricity currently stored in an electricity storage device. The connection information includes information for identifying whether or not an electrically driven vehicle is currently connected to the charge-discharge device 6. The tender information includes information on a past tender history and information on a currently placed tender. The contract information includes information on a past contract history and information for identifying whether or not a currently placed tender is contracted. The charge-discharge plan includes information on a charge-discharge plan of an electricity resource based on a contract. The charge-discharge actual result includes information on the charge-discharge result to the charge-discharge plan described above.

The trip information and the connection information are information that is used by the agent 2 of the electrically driven vehicle 5 (the mobile object agent), and thus are blank in the case of the facilities 7 (the factory 7A, the home 7D, etc.).

Referring back to FIG. 5, the external information 223 includes information on the climate (weather, atmospheric temperature, etc.) of a region of a P2P electricity transaction market on which a tender is to be placed, date and time, past indicative prices (renewable energy/non-renewable energy) in the P2P electricity transaction market, and so forth. The agent 2 acquires the external information 223 from an external server device (or the transaction market server 3) through the communication network 10.

The communication device 23 transmits and receives various data to and from the transaction market server 3 through the communication network 10. Further, the communication device 23 is also configured to be able to communicate with a user terminal 8 such as a smartphone. The user terminal 8 is a terminal device owned by a user of the corresponding electricity resource (in this example, the electrically driven vehicle 5). The user terminal 8 is able to receive various inquiries from the agent 2 and transmit answers to the received inquiries to the agent 2 (details will be described later).

The transaction market server 3 includes a processor 31, a memory 32, and a communication device 33. The transaction market server 3 is a device that manages P2P electricity transactions between electricity resources on a P2P electricity transaction market (a general transaction market and direct transaction markets), and performs processes for electricity transactions.

The processor 31 is an arithmetic processor (a computer) that performs various processes by executing various programs. The processor 31 is formed by a CPU, an FPGA, a GPU, and so forth. Alternatively, the processor 31 may be formed by a processing circuitry.

The memory 32 stores programs and data for the processor 31 to perform various processes. The memory 32 is formed by storage media such as a ROM and a RAM. The memory 32 stores an arithmetic program 321 and agent information 322.

The arithmetic program 321 is for identifying a process to be performed by the processor 31. For example, the arithmetic program 321 includes a program for performing a tender process that accepts tenders from a plurality of agents 2, and performing a contract process based on the tenders. The contract process executes a contract for an electricity transaction between a seller and a buyer with matching tender conditions and processes a tender with no condition matching counterpart as an uncontracted tender.

The agent information 322 includes information on the agents 2 participating in a P2P electricity transaction market managed by the transaction market server 3 and particularly includes information on a tender and a contract for an electricity transaction in each of the agents 2.

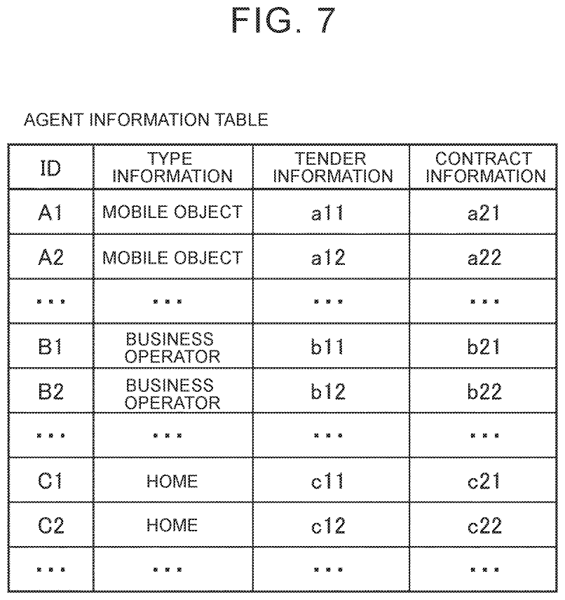

FIG. 7 is a diagram illustrating an example of the agent information 322. Referring to FIG. 7, the agent information 322 includes ID, type information, tender information, and contract information.

The ID includes identification information for identifying the agents 2 participating in a P2P electricity transaction market managed by the transaction market server 3. The type information includes information on the type of each of electricity resources and, for example, includes information for identifying an electrically driven vehicle, a business operator, a home, or the like. The tender information includes information on a past tender history and information on a currently placed tender in each of the agents 2. The contract information includes information on a past contract history and information for identifying whether or not a currently placed tender is contracted, in each of the agents 2.

Referring back to FIG. 5, the communication device 33 transmits and receives various data to and from the agents 2 through the communication network 10.

In the P2P electricity transaction market formed by the agents 2 and the transaction market server 3 described above, each of the agents 2 performs a use prediction of the corresponding electricity resource (in the case of the electrically driven vehicle 5, predicts a use of the electrically driven vehicle 5 by a user) and predicts an electricity transaction price in the electricity transaction market in a time period in which the electricity resource can participate in an electricity transaction. Then, the agent 2 prepares an electricity transaction plan (a tender plan) that is optimal in terms of cost under constraints of the SOC upper and lower limits (within a chargeable-dischargeable range) that should be satisfied in an electricity storage device of the corresponding electricity resource, and places a tender for an electricity transaction to the transaction market server 3.

Herein, when the electricity resource is the electrically driven vehicle 5, the actual action of a user may often differ from a use prediction of the vehicle by the agent 2 (the mobile object agent). When the use prediction of the vehicle by the agent 2 and the actual action of the user largely deviate from each other, the cost of penalty imposed due to transaction failure may be increased, the reliability of the user on the electricity transaction plan to be prepared may be reduced, and so forth.

Therefore, the agent 2 (the mobile object agent) of the present disclosure makes an inquiry to a user of the corresponding electrically driven vehicle 5 about an electricity transaction plan to be prepared. The agent 2 according to this embodiment makes an inquiry to a user of the corresponding electrically driven vehicle 5 about an electricity transaction plan before an electricity transaction according to the electricity transaction plan is contracted in the electricity transaction market. Consequently, it is possible to reflect an answer from the user on the preparation of an electricity transaction plan, or the user is able to match its action to the inquired electricity transaction plan, so that it is possible to prepare an electricity transaction plan in line with the action of the user.

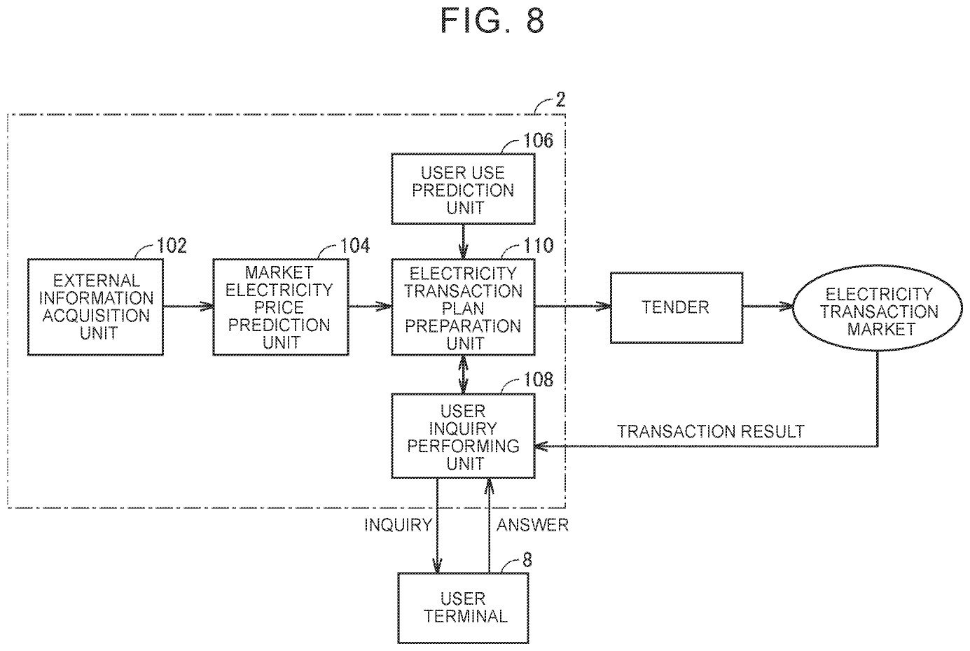

FIG. 8 is a block diagram functionally illustrating the configuration of the agent 2 (the mobile object agent) according to this embodiment. Referring to FIG. 8, the agent 2 of the electrically driven vehicle 5 includes an external information acquisition unit 102, a market electricity price prediction unit 104, a user use prediction unit 106, a user inquiry performing unit 108, and an electricity transaction plan preparation unit 110.

The external information acquisition unit 102 acquires climate information of a region of a P2P electricity transaction market on which a tender is to be placed, from an external server device (not illustrated). The climate information includes, for example, forecast of weather, atmospheric temperature, and so forth per time period. The P2P electricity transaction market on which a tender is to be placed is an electricity transaction market in a region where the corresponding electrically driven vehicle 5 wishes charging or discharging based on a P2P electricity transaction, and is determined based on a use prediction of the electrically driven vehicle 5. For example, it can be determined based on a predicted location (e.g., a place of destination or the like) of the electrically driven vehicle 5.

The external information acquisition unit 102 also acquires information on past indicative prices (renewable energy/non-renewable energy) in the P2P electricity transaction market on which a tender is to be placed, from the external server device (not illustrated). The indicative price information includes the transition of sell-buy prices of renewable energy electricity and the transition of sell-buy prices of non-renewable energy electricity. The information acquired by the external information acquisition unit 102 is stored in the memory 22 as the external information 223 (FIG. 5).

The market electricity price prediction unit 104 predicts prices (unit prices) of electricity (buying electricity and selling electricity) traded in the P2P electricity transaction market on which a tender is to be placed. In the P2P electricity transaction market in this embodiment, renewable energy electricity derived from electricity generation facilities of renewable energy (electricity generated by solar electricity generation facilities, wind-powered electricity generation facilities, water-powered electricity generation facilities, or the like) and non-renewable energy electricity (electricity derived from thermal electricity generation or the like) not relevant to the renewable energy electricity are traded distinctly from each other. For example, when trading renewable energy electricity, by giving a tag indicating that electricity to be traded is renewable energy electricity (a renewable energy tag), it is possible to distinguish renewable energy electricity from non-renewable energy electricity. Alternatively, a market dealing with transactions of renewable energy electricity and a market dealing with transactions of non-renewable energy electricity may be separated in the P2P electricity transaction market.

In this embodiment, the market electricity price prediction unit 104 predicts buying prices by distinguishing a price of renewable energy electricity and a price of non-renewable energy electricity from each other. For example, from the information on past indicative prices (renewable energy/non-renewable energy) in the tender-target P2P electricity transaction market acquired by the external information acquisition unit 102, the market electricity price prediction unit 104 predicts a price of renewable energy electricity and a price of non-renewable energy electricity in a tender wishing date and time (time period).

The user use prediction unit 106 predicts a use plan of a vehicle by a user of the corresponding electrically driven vehicle 5. Specifically, the user use prediction unit 106 predicts, in an arbitrary manner, future use situations of a vehicle, for example, a future travel schedule, connection to the charge-discharge device 6, a schedule of charge/supply, and so forth.

The user inquiry performing unit 108 transmits to the user terminal 8 an inquiry about an electricity transaction plan to be prepared by the electricity transaction plan preparation unit 110, which will be described later. Upon receipt of an answer to the inquiry from the user terminal 8, the user inquiry performing unit 108 notifies the result of the answer to the electricity transaction plan preparation unit 110.

The inquiry about the electricity transaction plan includes, for example, approval or disapproval of a user action plan (future travel schedule, connection to the charge-discharge device 6, schedule of charge/supply, etc.) predicted by the user use prediction unit 106.

In this embodiment, since renewable energy electricity and non-renewable energy electricity not relevant to the renewable energy electricity are traded distinctly from each other, the inquiry includes approval or disapproval of the ratio of renewable energy electricity (the renewable energy purchase ratio) accounting for electricity purchased through the P2P electricity transaction market. The renewable energy purchase ratio may be determined based on the past renewable energy purchase ratio, or may be one that was set from the user terminal 8 in the past.

Further, in this embodiment, the inquiry includes approval or disapproval of an electricity cost (an allowable transaction price) that is allowed in an electricity transaction through the P2P electricity transaction market. The allowable transaction price may be one that was set at the time of registration for participation in the P2P electricity transaction market, or may be one that was set from the user terminal 8 in the past.

In this embodiment, the inquiry about the electricity transaction plan is not performed about an electricity transaction plan itself to be prepared by the electricity transaction plan preparation unit 110, but is performed before preparing an electricity transaction plan and placing a tender by the electricity transaction plan preparation unit 110. That is, the inquiry to the user terminal 8 by the user inquiry performing unit 108 is performed before placing a tender on the P2P electricity transaction market.

The user inquiry performing unit 108 receives a transaction result (a contract result) in the P2P electricity transaction market (the transaction market server 3) from the transaction market server 3. Then, the user inquiry performing unit 108 notifies the received transaction result to the user terminal 8. Consequently, the user is able to evaluate the transaction result and, by sending the result of the evaluation as an answer, it is possible to reflect the transaction result on the preparation of an electricity transaction plan from the next time.

Based on electricity transaction prices predicted by the market electricity price prediction unit 104 and a use plan of a vehicle predicted by the user use prediction unit 106, the electricity transaction plan preparation unit 110 prepares an electricity transaction plan (a tender plan) for conducting an electricity transaction in the P2P electricity transaction market. As an example, the electricity transaction plan preparation unit 110 prepares an electricity transaction plan that is optimal in terms of cost under constraints of the SOC upper and lower limits (within a chargeable-dischargeable range) that should be satisfied in an electricity storage device of the corresponding electrically driven vehicle 5.

Herein, when the answer result on the inquiry to the user terminal 8 is received from the user inquiry performing unit 108, the electricity transaction plan preparation unit 110 prepares an electricity transaction plan reflecting the answer result. For example, when, to an inquiry about approval or disapproval of a user action plan (future travel schedule, connection to the charge-discharge device 6, schedule of charge/supply, etc.) predicted by the user use prediction unit 106, there is an answer requesting a modification of the user action plan, an electricity transaction plan is prepared based on a vehicle use plan reflecting the modification.

Alternatively, when, to an inquiry about approval or disapproval of the ratio of renewable energy electricity (the renewable energy purchase ratio) accounting for electricity purchased through the P2P electricity transaction market, there is an answer requesting a modification of the renewable energy purchase ratio, an electricity transaction plan reflecting the modification is prepared. Alternatively, when, to an inquiry about approval or disapproval of an electricity cost (an allowable transaction price) that is allowed in an electricity transaction through the P2P electricity transaction market, there is an answer requesting a modification of the allowable transaction price, an electricity transaction plan reflecting the modification is prepared.

In this way, in this embodiment, an inquiry about an electricity transaction plan is made to the user of the electrically driven vehicle 5 before the preparation of an electricity transaction plan by the electricity transaction plan preparation unit 110, i.e., before the execution of a contract for a tender on the P2P electricity transaction market. Consequently, it is possible to reflect an answer from the user to the inquiry on the preparation of the electricity transaction plan. Alternatively, the user is able to match its action to the inquired electricity transaction plan. As a result, the deviation between the use prediction of the vehicle by the agent 2 and the action of the user can be suppressed so that it is possible to suppress the cost of penalty imposed due to transaction (contract) failure.

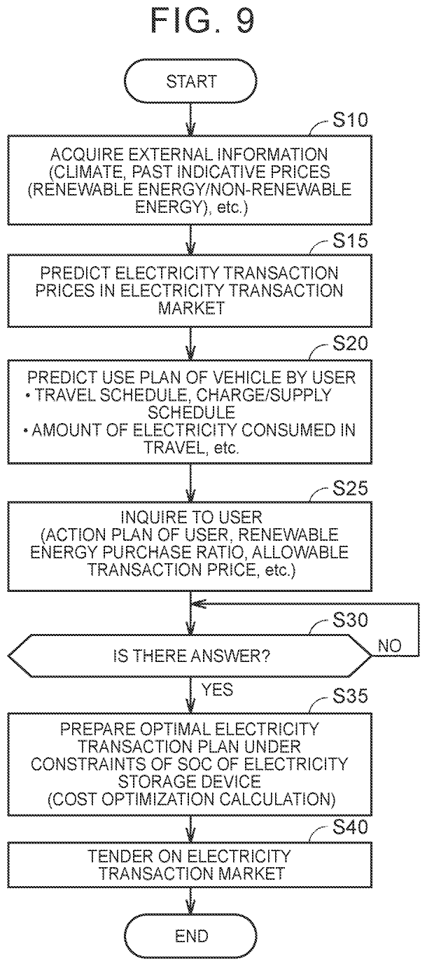

FIG. 9 is a flowchart illustrating an example of a procedure of processing that is performed when the agent 2 places a tender on a P2P electricity transaction market. Referring to FIG. 9, the agent 2 (the processor 21) acquires external information on a P2P electricity transaction market on which a tender is to be placed, from an external server device through the communication network 10 (step S10). The external information includes climate information (weather, atmospheric temperature, etc. per time period) of a region covered by the market, information on past indicative prices in the market, and so forth. The indicative price information includes the transition of sell-buy prices of renewable energy electricity and the transition of sell-buy prices of non-renewable energy electricity.

Then, the agent 2 predicts prices (unit prices) of electricity (buying electricity and selling electricity) traded on the tender-target P2P electricity transaction market (step S15). In this embodiment, since renewable energy electricity and non-renewable energy electricity are traded distinctly from each other, the agent 2 predicts a transaction price of renewable energy electricity and a transaction price of non-renewable energy electricity distinctly from each other. Specifically, the agent 2 predicts a price of renewable energy electricity and a price of non-renewable energy electricity in a tender wishing date and time (time period) from the information on past indicative prices acquired at step S10.

Further, the agent 2 predicts a use plan of a vehicle by a user of the corresponding electrically driven vehicle 5 (step S20). For example, the agent 2 predicts a future travel schedule, connection to the charge-discharge device 6, a schedule of charge/supply, an amount of electricity consumed in travel, and so forth.

Then, the agent 2 transmits an inquiry about an electricity transaction plan to be prepared, to the user terminal 8 (step S25). The inquiry includes approval or disapproval of the action plan of the user predicted at step S20. The inquiry may further include approval or disapproval of the ratio of renewable energy electricity (the renewable energy purchase ratio) accounting for electricity purchased through the P2P electricity transaction market, approval or disapproval of an electricity cost (an allowable transaction price) that is allowed in an electricity transaction through the P2P electricity transaction market, and so forth.

Then, upon receipt of an answer to the inquiry from the user terminal 8 (YES at step S30), the agent 2 prepares an electricity transaction plan (a tender plan) reflecting the result of the answer. For example, when there is an answer requesting a modification of the action plan of the user to an inquiry about approval or disapproval of the action plan of the user, the agent 2 modifies the vehicle use plan of the user based on the answer. Then, based on the modified use plan, the agent 2 prepares an electricity transaction plan that is optimal in terms of cost under constraints of the SOC upper and lower limits (within a chargeable-dischargeable range) that should be satisfied in an electricity storage device of the corresponding electrically driven vehicle 5 (step S35).

When there is an answer requesting a modification to an inquiry about approval or disapproval of the renewable energy purchase ratio, the agent 2 prepares an optimal electricity transaction plan according to the modified renewable energy purchase ratio. Alternatively, when there is an answer requesting a modification to an inquiry about approval or disapproval of the allowable transaction price, the agent 2 prepares an optimal electricity transaction plan within the modified allowable transaction price.

Then, when the electricity transaction plan is prepared at step S35, the agent 2 places a tender on the P2P electricity transaction market (the transaction market server 3) based on the prepared electricity transaction plan (step S40).

When there is no answer from the user terminal 8 for a predetermined time at step S30, the agent 2 may transmit an inquiry to the user terminal 8 again, and when there is no answer to a plurality of inquiries, the agent 2 may advance the processing to step S35.

As described above, in this embodiment, an inquiry about an electricity transaction plan is made to a user by the user inquiry performing unit 108 before a tender on the P2P electricity transaction market, i.e., before a contract in the P2P electricity transaction market, and therefore, it is possible to reflect an answer from the user on the preparation of an electricity transaction plan, or the user is able to match its action to the inquired electricity transaction plan. Consequently, according to this embodiment, the agent 2 is able to prepare an electricity transaction plan in line with an action of the vehicle user.

Further, in this embodiment, an inquiry about a user action plan using the electrically driven vehicle 5 is made to a user by the user inquiry performing unit 108, and an electricity transaction plan reflecting an answer from the user to the inquiry is prepared by the electricity transaction plan preparation unit 110. Consequently, it is possible to suppress a deviation between a use prediction of the vehicle and an action of the user so that it is possible to prepare an electricity transaction plan reflecting the action plan of the vehicle user.

Further, in this embodiment, an inquiry about the renewable energy purchase ratio may be made to a user by the user inquiry performing unit 108, and an electricity transaction plan reflecting an answer from the user to the inquiry may be prepared by the electricity transaction plan preparation unit 110. Alternatively, an inquiry about the allowable transaction price may be made to a user by the user inquiry performing unit 108, and an electricity transaction plan reflecting an answer from the user to the inquiry may be prepared by the electricity transaction plan preparation unit 110. Consequently, the user is able to answer on the renewable energy purchase ratio or the allowable transaction price so that it is possible to improve the user's usability to the agent 2.

In the above description, the user use prediction unit 106 may make learning by linking calendar information to a past action history of a user to learn a periodic action or a seasonal action of the user. Then, using the result of the learning, an action plan of the user (future travel schedule, connection to the charge-discharge device 6, schedule of charge/supply, etc.), an amount of electricity consumed in travel, and so forth may be predicted. Consequently, it is possible to prepare an electricity transaction plan more suitable for the action of the user.

First Modification

In the embodiment described above, the inquiry about the user action plan and so forth is made to the user (the user terminal 8) before the preparation of the electricity transaction plan, but an inquiry may be made to the user about approval or disapproval of the prepared electricity transaction plan itself.

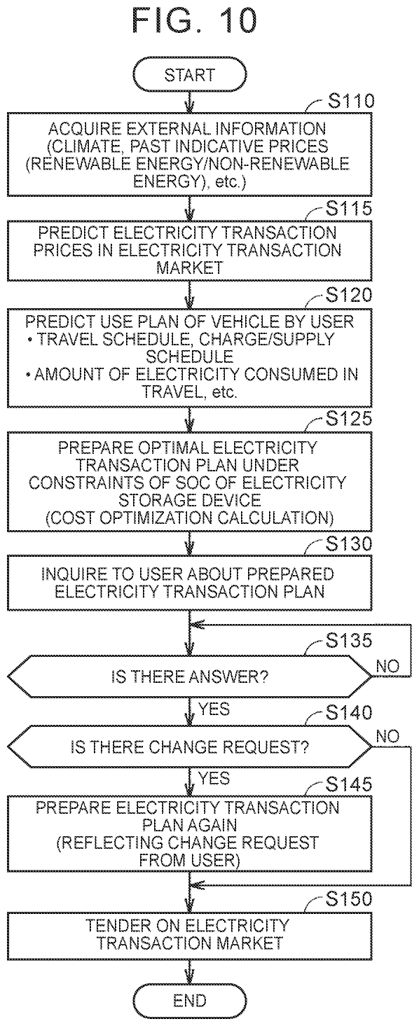

FIG. 10 is a flowchart illustrating an example of a processing procedure of the agent 2 according to a first modification. This flowchart corresponds to the flowchart of FIG. 9 described in the embodiment described above.

Referring to FIG. 10, the processes of steps S110, S115, and S120 are respectively the same as the processes of steps S10, S15, and S20 of the flowchart illustrated in FIG. 9.

In this flowchart, when a use plan of a vehicle by a user is predicted at step S120, the agent 2 prepares, based on electricity transaction prices predicted at step S115 and the use plan of the vehicle predicted at step S120, an electricity transaction plan that is optimal in terms of cost under constraints of the SOC upper and lower limits (within a chargeable-dischargeable range) that should be satisfied in an electricity storage device of the corresponding electrically driven vehicle 5 (step S125).

Then, the agent 2 transmits an inquiry about approval or disapproval of the prepared electricity transaction plan to the user terminal 8 (step S130). Then, upon receipt of an answer to the inquiry from the user terminal 8 (YES at step S135), the agent 2 determines whether or not the answer requests a change in the electricity transaction plan (step S140).

When the answer to the inquiry requests the change in the electricity transaction plan (YES at step S140), the agent 2 prepares again an electricity transaction plan reflecting the change (step S145). When the answer does not request the change in the electricity transaction plan at step S140 (NO at step S140), the process of step S145 is not performed.

Then, the agent 2 places a tender on the P2P electricity transaction market (the transaction market server 3) based on the electricity transaction plan prepared at step S125 or the electricity transaction plan prepared again at step S145 (step S150).

In the above description, in combination with the embodiment described above, the agent 2 may further make an inquiry about an action plan of the user and so forth to the user (the user terminal 8) before preparing the electricity transaction plan. Further, the agent 2 may prepare a plurality of electricity transaction plans based on an answer to the inquiry and may further make an inquiry about approval or disapproval of the prepared electricity transaction plans.

As described above, according to the first modification, the user is able to answer about approval or disapproval of the prepared electricity transaction plan so that the agent 2 is able to prepare an electricity transaction plan reflecting the answer from the user. Consequently, the user's usability to the agent 2 is improved.

Second Modification

In the first modification described above, the inquiry about approval or disapproval of the prepared electricity transaction plan is made to the user (the user terminal 8), and when the answer requests a change in the electricity transaction plan, an electricity transaction plan reflecting the change is prepared again. On the other hand, an inquiry may be made to the user about an evaluation of the prepared electricity transaction plan, and the evaluation obtained from the user may be reflected on the preparation of an electricity transaction plan from the next time.

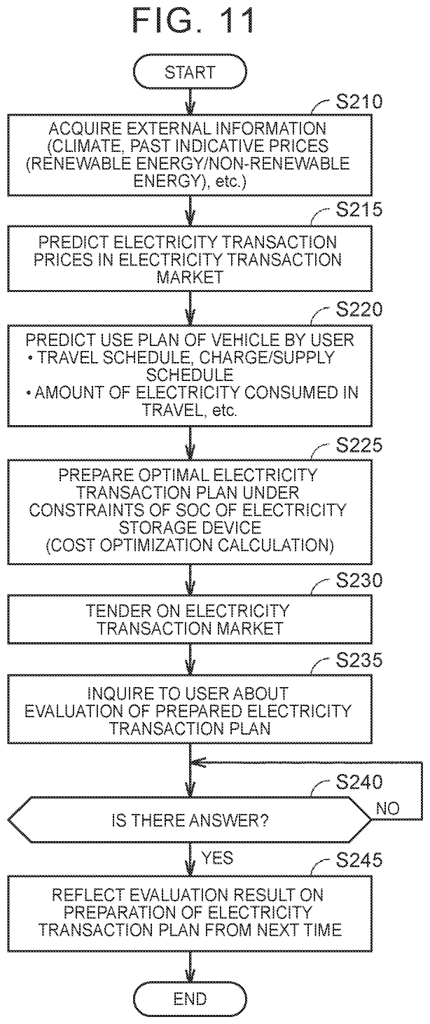

FIG. 11 is a flowchart illustrating an example of a processing procedure of the agent 2 according to a second modification. This flowchart also corresponds to the flowchart of FIG. 9 described in the embodiment described above.

Referring to FIG. 11, the processes of steps S210 to S225 are respectively the same as the processes of steps S110 to S125 of the flowchart illustrated in FIG. 10.

In this flowchart, when an electricity transaction plan is prepared at step S225, the agent 2 places a tender on the P2P electricity transaction market (the transaction market server 3) based on the prepared electricity transaction plan (step S230). Then, the agent 2 transmits an inquiry about an evaluation of the prepared electricity transaction plan to the user terminal 8 (step S235).

Then, upon receipt of an answer (the evaluation of the electricity transaction plan) to the inquiry from the user terminal 8 (YES at step S240), the agent 2 reflects the obtained evaluation on the preparation of an electricity transaction plan from the next time (step S245). For example, when the evaluation points out a discrepancy in a vehicle use plan in a certain time period, the agent 2 may prepare an electricity transaction plan so as not to place a tender in that time period from the next time. Alternatively, when the evaluation is related to a discrepancy about the renewable energy purchase ratio, the agent 2 may prepare the next electricity transaction plan reflecting the discrepancy.

Although, in the above description, the inquiry about the evaluation of the prepared electricity transaction plan is performed after the tender is placed, the inquiry may be transmitted to the user terminal 8 before placing the tender or simultaneously with the tender. In the second modification, the inquiry about the evaluation of the prepared electricity transaction plan is performed before the tender is contracted.

As described above, according to the second modification, the user is able to answer about the evaluation of the prepared electricity transaction plan so that the user's evaluation of the electricity transaction plan can be reflected on the preparation of the next electricity transaction plan. Consequently, the user's usability to the agent 2 is further improved.

Third Modification

In a third modification, a contract result of an electricity transaction according to a prepared electricity transaction plan (tender plan) is notified to a user (the user terminal 8). Further, an evaluation of the contract result obtained from the user can be reflected on the preparation of an electricity transaction plan from the next time.

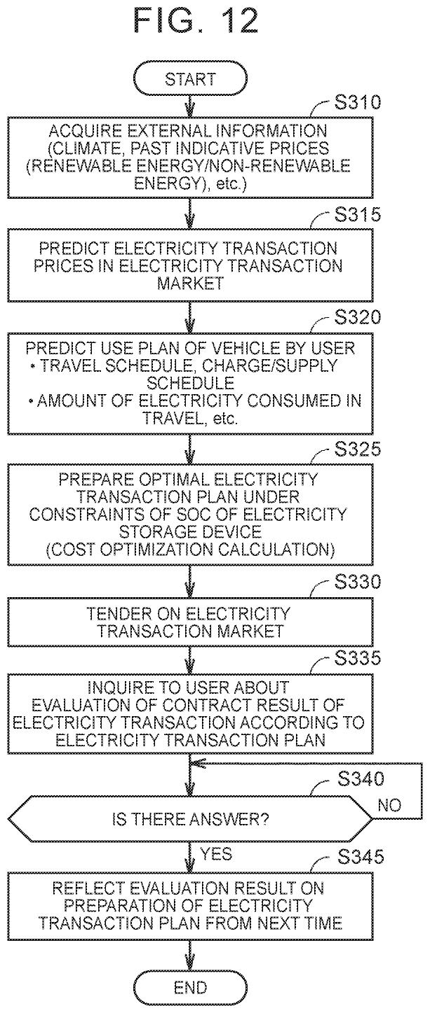

FIG. 12 is a flowchart illustrating an example of a processing procedure of the agent 2 according to the third modification. This flowchart also corresponds to the flowchart of FIG. 9 described in the embodiment described above.

Referring to FIG. 12, the processes of steps S310 to S330 are respectively the same as the processes of steps S210 to S230 of the flowchart illustrated in FIG. 11.

In this flowchart, when a tender is placed based on a prepared electricity transaction plan at step S330, the agent 2 transmits to the user terminal 8 an inquiry about an evaluation of a contract result of an electricity transaction according to the electricity transaction plan (step S335).

Then, upon receipt of an answer (the evaluation of the contract result) to the inquiry from the user terminal 8 (YES at step S340), the agent 2 reflects the obtained evaluation of the contract result on the preparation of an electricity transaction plan from the next time (step S345).

In the above description, in combination with the embodiment described above, the agent 2 may further make an inquiry to the user before placing the tender, or in combination with the first modification or the second modification, the agent 2 may further make an inquiry to the user before placing the tender or after placing the tender (before the tender is contracted).

As described above, according to the third modification, since the user inquiry performing unit 108 notifies to the user the contract result of the electricity transaction in the electricity transaction market according to the electricity transaction plan, the user is able to evaluate the contract result and answer about the result of the evaluation so that it is possible to reflect the contract result on the preparation of an electricity transaction plan from the next time.

In the third modification, the user inquiry performing unit 108 receives the user's evaluation of the contract result, and the electricity transaction plan preparation unit 110 is able to reflect the obtained evaluation of the contract result on the preparation of the next electricity transaction plan. Consequently, the user's usability to the agent 2 is further improved.

The notification to the user (the user terminal 8) from the agent 2 (the user inquiry performing unit 108) may include information on a transaction counterpart, the ratio of renewable energy electricity (the renewable energy ratio) in electricity to be purchased, and so forth.

Fourth Modification

In a fourth modification, an inquiry to a user (the user terminal 8) is performed when the user gets on/off the corresponding electrically driven vehicle 5. Since the inquiry is made to the user at the timing when the user uses the electrically driven vehicle 5, it is possible to enhance the possibility to obtain an answer from the user to the inquiry so that it is possible to prepare an electricity transaction plan that is more in line with an action of the user.

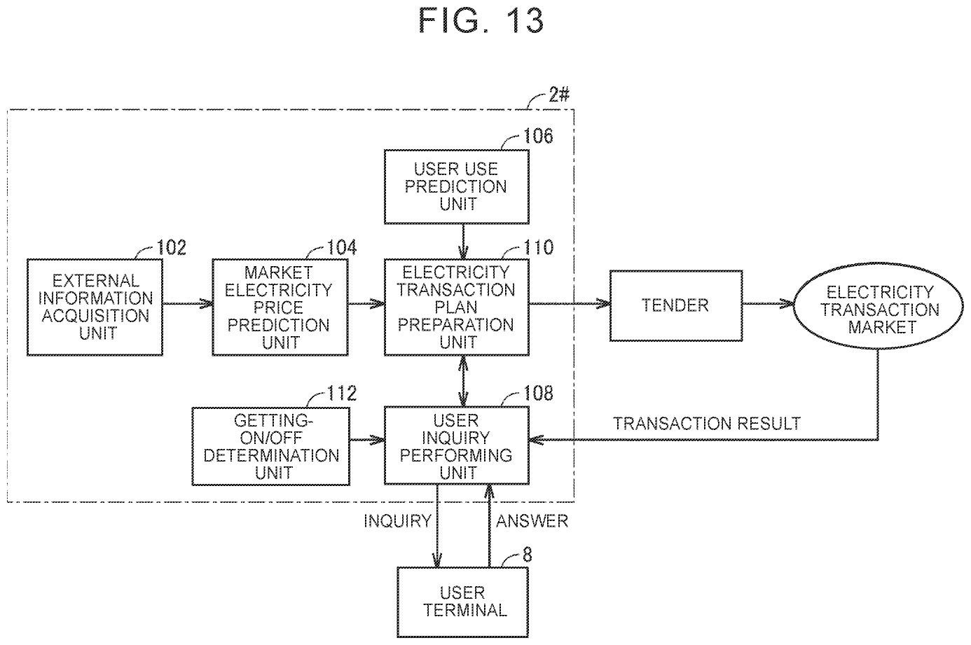

FIG. 13 is a block diagram functionally illustrating the configuration of an agent 2# (a mobile object agent) in the fourth modification. Referring to FIG. 13, the agent 2# further includes a getting-on/off determination unit 112 in the configuration of the agent 2 illustrated in FIG. 8.

The getting-on/off determination unit 112 determines getting-on/off of the user with respect to the corresponding electrically driven vehicle 5. The getting-on/off of the user can be determined by various methods. For example, the getting-on/off of the user may be determined by opening and closing of a door on the driver's seat side or may be determined by the driver's seat being occupied and unoccupied. Upon detection of the getting-on/off of the user, the getting-on/off determination unit 112 notifies it to the user inquiry performing unit 108.

Then, upon receipt of a notification from the getting-on/off determination unit 112 that there is the getting-on/off of the user, the user inquiry performing unit 108 transmits an inquiry about an electricity transaction plan to the user terminal 8.

Although, in the above description, the getting-on/off determination unit 112 determines the getting-on/off of the user with respect to the corresponding electrically driven vehicle 5, the getting-on/off determination unit 112 may determine only the getting-on or getting-off of the user with respect to the corresponding electrically driven vehicle 5.

As described above, according to the fourth modification, it is possible to enhance the possibility to obtain an answer from the user to the inquiry so that it is possible to prepare an electricity transaction plan that is more in line with an action of the user.

It is expected that the embodiments disclosed herein may be implemented by being combined as appropriate within a technically consistent range. The embodiments disclosed herein should be construed to be illustrative and not limitative in all aspects. The technical scope defined by the present disclosure is defined by the scope of the claims rather than the description of the embodiments described above and is intended to include all modifications within the scope of the claims and within the meaning and scope of equivalents of the claims.

What is claimed is:

1. An information processing device configured to prepare an electricity transaction plan for a vehicle as an electricity resource to conduct an electricity transaction through an electricity transaction market, the information processing device comprising:
a price prediction unit configured to predict a transaction price of electricity traded in the electricity transaction market;
a use prediction unit configured to predict a use plan of the vehicle by a user of the vehicle;
a transaction plan preparation unit configured to prepare the electricity transaction plan based on a prediction result of the price prediction unit and a prediction result of the use prediction unit; and
an inquiry performing unit configured to make an inquiry to the user about the electricity transaction plan before an electricity transaction according to the electricity transaction plan is contracted in the electricity transaction market.

2. The information processing device according to claim 1, wherein:
the inquiry performing unit is configured to make an inquiry to the user about an action plan of the user using the vehicle; and
the transaction plan preparation unit is configured to prepare the electricity transaction plan reflecting an answer from the user to the inquiry.

3. The information processing device according to claim 1, wherein:
the inquiry performing unit is configured to make an inquiry to the user about a ratio of renewable energy electricity accounting for electricity purchased in the electricity transaction market; and
the transaction plan preparation unit is configured to prepare the electricity transaction plan reflecting an answer from the user to the inquiry.

4. The information processing device according to claim 1, wherein:
the inquiry performing unit is configured to make an inquiry to the user about an electricity cost allowable when an electricity transaction is conducted in the electricity transaction market; and
the transaction plan preparation unit is configured to prepare the electricity transaction plan reflecting an answer from the user to the inquiry.

5. The information processing device according to claim 1, wherein:
the inquiry performing unit is configured to make an inquiry to the user about approval or disapproval of the electricity transaction plan prepared by the transaction plan preparation unit; and
the transaction plan preparation unit is configured to prepare again the electricity transaction plan reflecting an answer from the user to the inquiry.

6. The information processing device according to claim 1, wherein:
the inquiry performing unit is configured to make an inquiry to the user about an evaluation of the electricity transaction plan prepared by the transaction plan preparation unit; and
the transaction plan preparation unit is configured to prepare the electricity transaction plan reflecting an answer of the evaluation from the user to the inquiry.

7. The information processing device according to claim 1, wherein the inquiry performing unit is configured to notify to the user a contract result of an electricity transaction according to the electricity transaction plan.

8. The information processing device according to claim 1, wherein:
the inquiry performing unit is configured to make an inquiry to the user about an evaluation of a contract result of an electricity transaction according to the electricity transaction plan; and
the transaction plan preparation unit is configured to prepare the electricity transaction plan reflecting an answer of the evaluation from the user to the inquiry.
